(19) United States
(12) Patent Application Publication
(10) Pub. No.: US 2007/0215701 A1
(43) Pub. Date: Sep. 20, 2007

(54) Information processing device that writes data to an attachable/detachable recording medium and control method thereof

(75) Inventor: Tsuyoshi Takimoto, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/500,375

(22) Filed: Aug. 8, 2006

(30) Foreign Application Priority Data
Mar. 17, 2006 (JP) JP2006-074590

(51) Int. Cl. G06K 7/00; G06K 7/06

(52) U.S. Cl. 235/435; 235/441

(57) ABSTRACT

To prevent original data as a write target data from being destructed in the case of writing the data to a recording medium. An information processing device that writes data to an attachable/detachable recording medium includes data segmenting unit segmenting the data, data writing unit writing the data segmented by the data segmenting unit to the recording medium, and detecting unit detecting ejection of the attached recording medium, wherein the data writing unit stops writing when the detecting unit detects the ejection of the recording medium.

### BACKGROUND OF THE INVENTION

The present invention relates to an information processing device.

A digital device such as a personal computer and a printer is provided with a slot for transmitting and receiving data (image data) captured by a digital camera, a video camera, etc to and from the digital camera and the video camera. Further, for user's serviceability, a recording medium is attached and detached to and from the personal computer in a power-on status of a power source of a main body of the personal computer.
[Patent document 1] Japanese Patent Application Laid-Open Publication No.2005-93381

### SUMMARY OF THE INVENTION

In the midst of writing the data to the recording medium, there is a case where the recording medium might be ejected from the personal computer. In this case, such a possibility arises that the original data as write target data might be destructed. Another possibility is that incomplete data interrupted in its writing might remain on the recording medium. It is therefore an object of the present invention to provide a technology capable of preventing the original data as the write target data from being destructed in the case of writing the data to the recording medium. It is another object of the present invention to provide a technology capable of preventing the incomplete data interrupted in its writing from remaining on the recording medium in the case of writing the data to the recording medium.

The present invention adopts the following means in order to solve the problems. Namely, according to the present invention, an information processing device that writes data to an attachable/detachable recording medium comprises data segmenting means segmenting the data, data writing means writing the data segmented by the data segmenting means to the recording medium, and detecting means detecting ejection of the attached recording medium, wherein the data writing means stops writing when the detecting means detects the ejection of the recording medium. According to the present invention, in the case of detecting the ejection of the recording medium, the writing to the recording medium is stopped. It is therefore possible to prevent the original data as the write target data from being destructed.

Further, the information processing device according to the present invention may further comprise deleting means deleting, when the detecting means detects the ejection of the recording medium, the data written by the writing means from the recording medium. According to the present invention, if the recording medium is ejected in the midst of writing the data to the recording medium, it is feasible to prevent the data interrupted in its writing from remaining on the recording medium.

Moreover, the information processing device according to the present invention may further comprise means registering a write record of the data written to the recording medium by the data writing means in the data segmented by the data segmenting means, wherein the delete means deletes, based on the write record, the data written by the writing means from the recording medium. According to the present invention, the written data can be deleted from the recording medium by use of the write record of the data written to the recording medium.

Further, the present invention may be a method by which a computer, other devices, machines, etc execute any one of the processes described above. Still further, the present invention may also be a program that makes the computer, other devices, machines, etc actualize any one of the functions described above. Yet further, the present invention may also be a recording medium recorded with such a program, which can be read by the computer etc.

According to the present invention, the original write data can be prevented from being destructed in the case of writing the data to the recording medium. Further, according to the present invention, the incomplete data interrupted in its writing can be prevented from remaining on the recording medium in the case of writing the data to the recording medium.

### BRIEF DESCRIPTION OF THE DRAWINGS

FIG. 1 is a block diagram of pieces of hardware of a device body 1.

FIG. 2 is an explanatory diagram of an operation of a card slot 11.

FIG. 3 is an explanatory diagram of the operation of the card slot 11.

FIG. 4 is an explanatory diagram of the operation of the card slot 11.

FIG. 5 is an explanatory diagram of the operation of the card slot 11.

FIG. 6 is an explanatory diagram of the operation of the card slot 11.

FIG. 7 is an explanatory diagram of the operation of the card slot 11.

FIG. 8 is an explanatory diagram of an ejection detecting switch.

FIG. 9 is an explanatory diagram of the ejection detecting switch.

FIG. 10 is an explanatory diagram of an ejection detecting circuit.

FIG. 11 is a diagram showing a connecting relationship between the card slot 11, an EC 7, a chip set 3 and a control unit 2.

FIG. 12 is a conceptual diagram explaining an operation when making a write request and an operation when interrupt occurs.

FIG. 13 is a flowchart of an operation when starting up a filter driver 22.

### DETAILED DESCRIPTION OF THE INVENTION

An information processing device according to a best mode (which will hereinafter be termed an embodiment) for carrying out the present invention will hereinafter be described with reference to the drawings. A configuration in the following embodiment is an exemplification, and the present invention is not limited to the configuration in the embodiment.

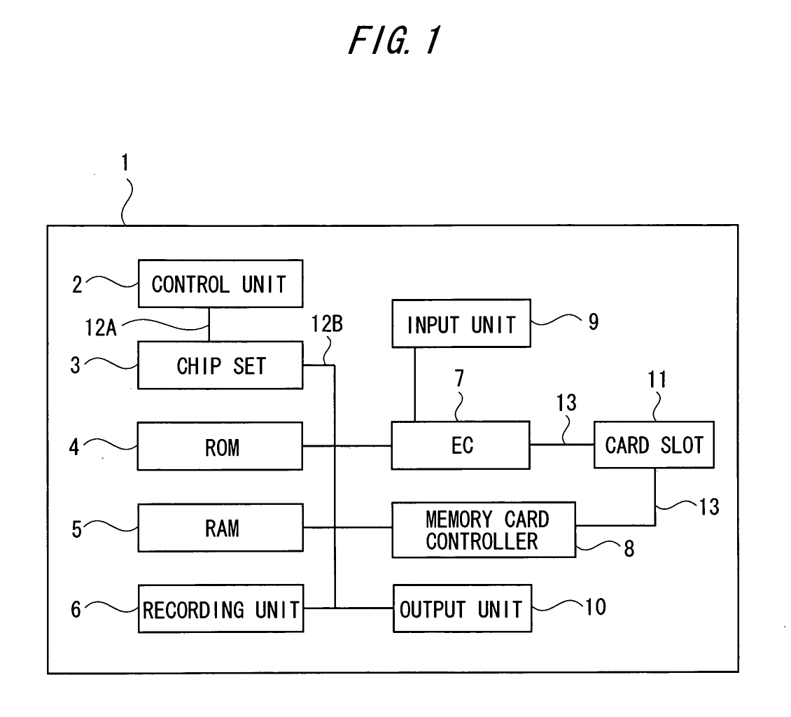

FIG. 1 shows a block diagram of pieces of hardware of a device body 1 provided in the information processing device. The device body 1 includes a control unit 2, a chip set 3, a ROM (Read Only Memory) 4, a RAM (Random Access Memory) 5, a recording unit 6, an EC (Embedded Controller) 7, a memory card controller 8, an input unit 9, an output unit 10 and a card slot 11. The control unit 2 is exemplified such as a CPU (Central Processing Unit) and executes a variety of processes according to a program stored in the ROM 4 or the RAM 5. The control unit 2 and the chip set 3 are connected to each other via a bus 12A. The ROM 4, the RAM 5, the recording unit 6, the EC 7, the memory card controller 8 and the output unit 10 are connected via a bus 12B to the chip set 3. The input unit 9 is connected to the EC 7. The chip set 3 controls connections to the respective units connected to the control unit 2 and to the chip set 3.

The ROM 4 is stored with a program required for the present information processing device to function and with parameters. The RAM 5 is temporarily stored with part of a program of operating system (OS) and an application program, which are executed by the control unit 2. The recording unit 6 is employed as an external storage for the present information processing device. The EC 7 is connected via a signal line to the card slot 11. The memory card controller 8 is connected via a signal line to the card slot 11. The card slot 11 enables insertion of a memory card defined as a storage medium having a built-in semiconductor memory.

The input unit 9 is exemplified such as a keyboard and a mouse, and is operated when inputting a predetermined command and a necessary item of data. The output unit 10 includes a display device such as a CRT (Cathode Ray Tube), a liquid crystal display and a plasma display, an audio output device such as a speaker, and an output device such as a printer device.

Further, the information processing device in the present embodiment can be actualized as an information device such as a personal computer, a mobile information terminal and a mobile phone.

Next, an operation of a card slot 11 included in the information processing device in the present embodiment will be explained.

### <Insertion of Memory Card>

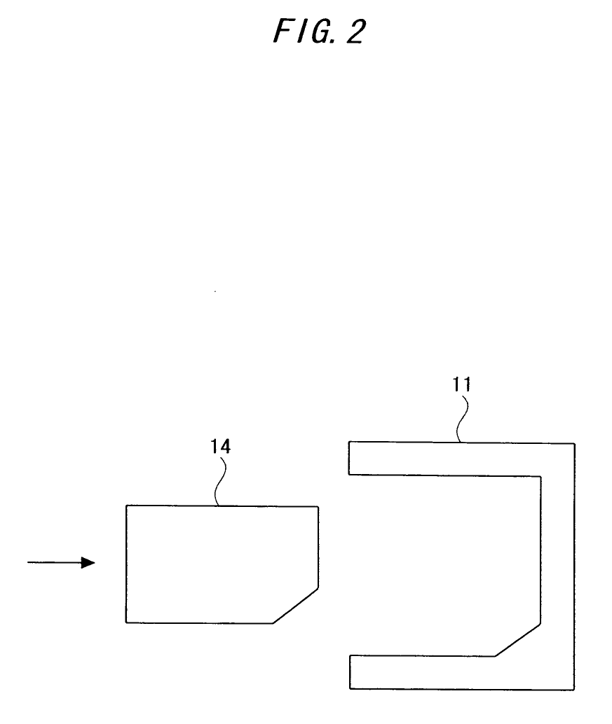

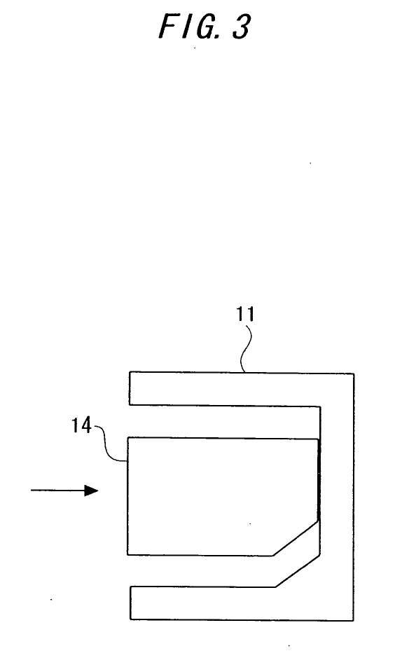

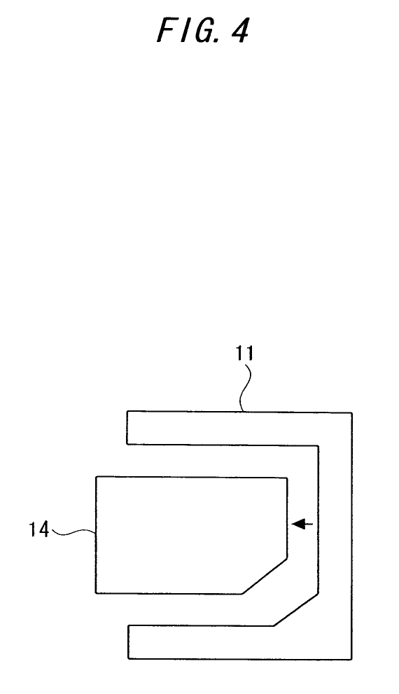

In the case of inserting the memory card 14 into the card slot 11, the memory card 14 is pushed in a direction indicated by an arrowhead in FIG. 2. As depicted in FIG. 3, the memory card 14 is intruded up to an innermost portion within the card slot 11. When the memory card 14 is intruded up to the innermost portion within the card slot 11, the memory card 14 is returned to a position just anterior to the innermost portion within the card slot 11. Then, as shown in FIG. 4, the memory card 14 is locked in the position just anterior to the innermost portion within the card slot 11. A locking function within the card slot 11 is broadly known, and therefore its explanation is omitted herein.

The card slot 11 is provided with an unillustrated terminal for electrically connecting the memory card 14 to the card slot 11. The memory card 14 is locked in the position just anterior to the innermost portion within the card slot 11, and an unillustrated electrode provided on the memory card 14 is brought into contact with the terminal of the card slot 11. The electrode provided on the memory card 14 is electrically connected to the terminal of the card slot 11, thereby enabling the information processing device to access the memory card 14.

<Ejection of Memory Card>

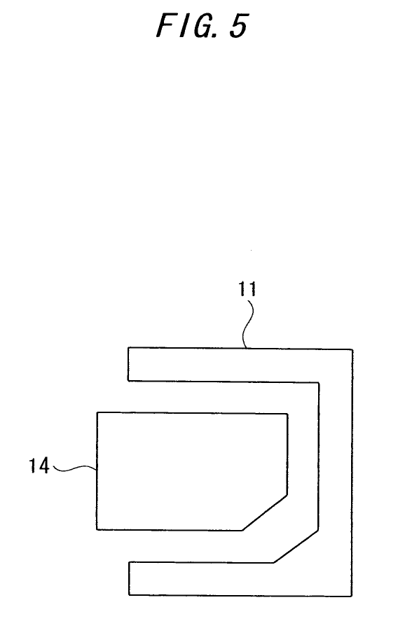

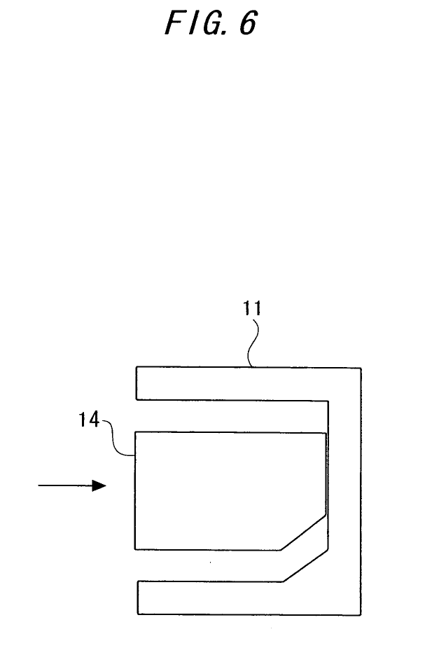

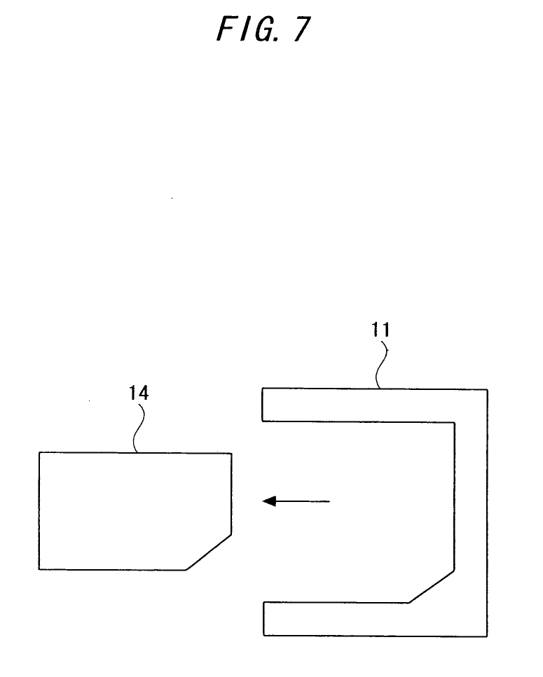

As illustrated in FIG. 5, the memory card 14 is locked in the position just anterior to the innermost portion within the card slot 11. In the case of ejecting the memory card 14 from the card slot 11, the memory card 14 is pushed in a direction indicated by an arrowhead in FIG. 6. When the memory card 14 is intruded up to the innermost portion within the card slot 11, as depicted in FIG. 7, the memory card 14 is ejected out of the card slot 11.

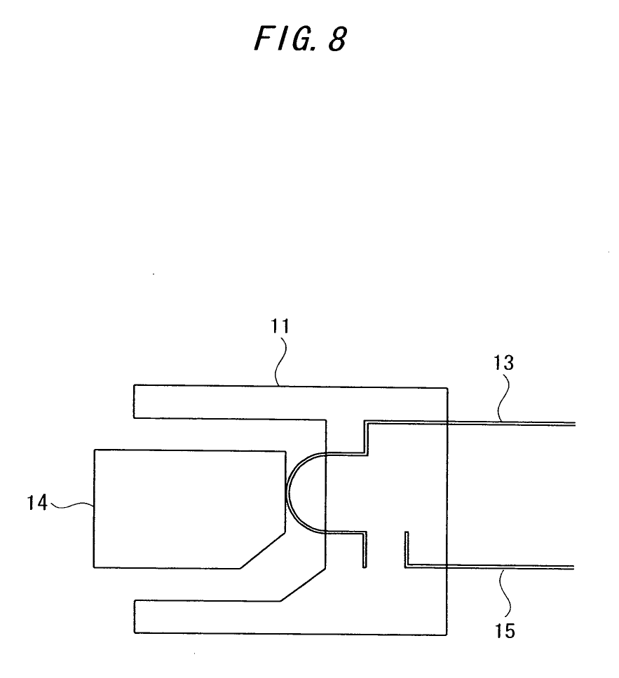

Next, the card slot 11 provided with an ejection detecting switch will be described. To begin with, the ejection detecting switch is provided on the card slot 11. Specifically, as shown in FIG. 8, the card slot 11 is connected to a signal line 13 and is further connected to a signal line 15.

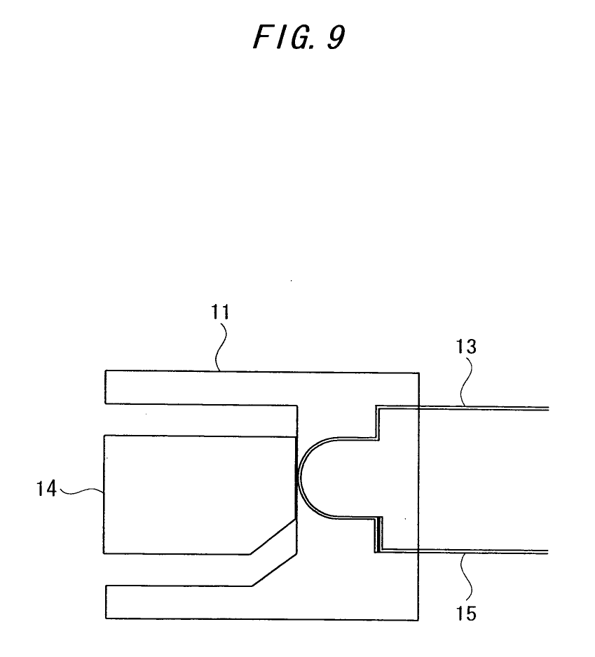

As depicted in FIG. 8, when the memory card 14 is locked in the position just anterior to the innermost portion within the card slot 11, the signal line 13 is not brought into contact with the signal line 15. As illustrated in FIG. 9, when the memory card 14 is intruded up to the innermost portion within the card slot 11, the signal line 13 is brought into contact with the signal line 15.

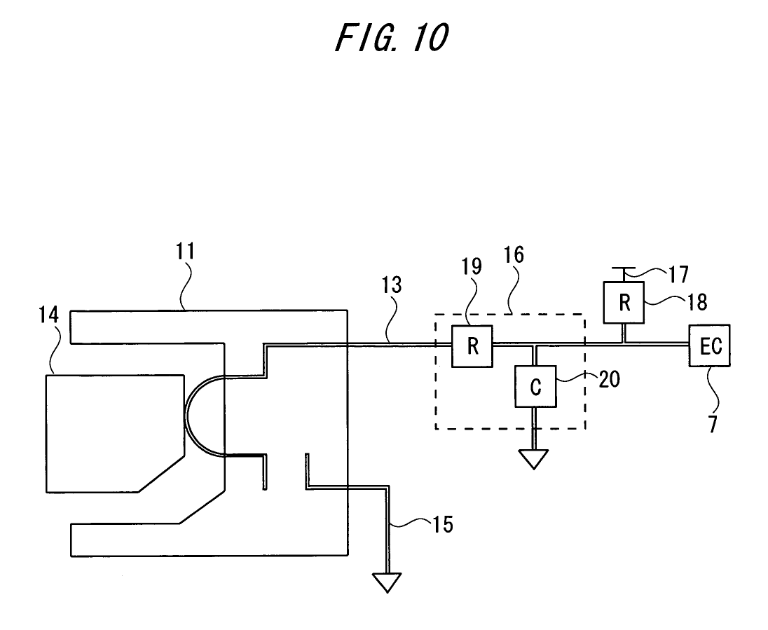

Next, an ejection detecting circuit will be explained. As shown in FIG. 10, the signal line 13 is provided with a chattering removal circuit 16. Further, the signal line 13 is provided with a Vcc power source 17. Then, a resistance 18 is provided between the signal line 13 and the Vcc power source 17. The chattering removal circuit 16 is constructed of a resistance 19 and a capacitor 20. The chattering removal circuit 16 is a circuit that removes chattering of the signal received by the EC 7 via the signal line 13. The signal line 13 is grounded. The capacitor 20 is provided between the signal line 13 and the ground. Further, the signal line 15 is grounded. Moreover, the signal line 13 is connected to the EC 7.

When the memory card 14 is locked in the position just anterior to the innermost portion within the card slot 11, the signal line 13 and the signal line 15 are not brought into contact with each other. Hence, the EC 7 receives a High-level signal via the signal line 13.

When the memory card 14 is intruded up to the innermost portion within the card slot 11, the signal line 13 and the signal line 15 are brought into contact with each other. Therefore, the EC 7 receives a Low-level signal via the signal line 13. In the case of ejecting the memory card 14 out of the card slot 11, the memory card 14 is intruded up to the innermost portion within the card slot 11. In this case, the EC 7 receives the Low-level signal via the signal line 13.

The High- or Low-level signal received by the EC 7 via the signal line 13 is employed as an interrupt signal. Normally, a plurality of interrupt signals exists Therefore, the signal line 13 is connected not to the control unit 2 but to the EC 7. Then, the High- or Low-level signal received by the EC 7 via the signal line 13 is transmitted to the control unit 2 via the chip set 3. The interrupt signal received by the EC 7 via the signal line 13 is recorded in a register within the EC 7. The Low-level signal recorded in the register within the EC 7 is set as a card ejection interrupt signal.

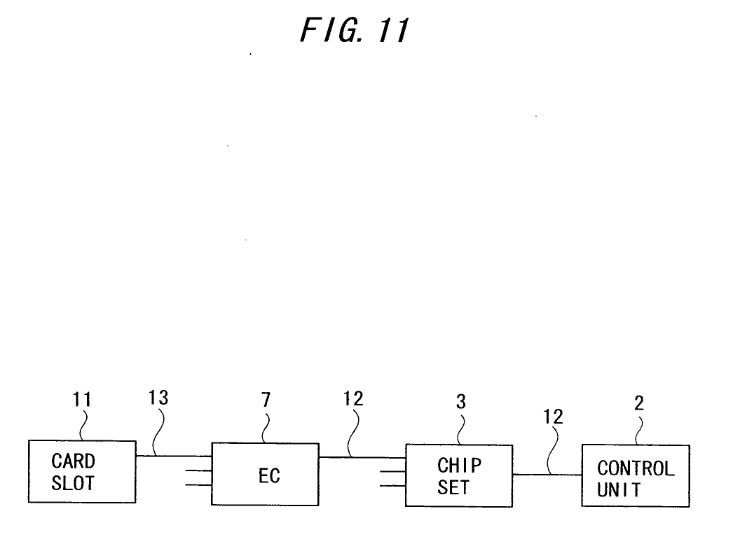

FIG. 11 is a diagram showing a connecting relationship between the card slot 11, the EC 7, the chip set 3 and the control unit 2. As depicted in FIG. 11, a plurality of interrupt signal lines is connected to the EC 7. One of the plurality of interrupt signal lines connected to the EC 7 is the signal line 13. The EC 7 receives the interrupt signals via the plurality of interrupt signal lines. Then, the EC 7 transmits to the chip set 3 the interrupt signals received via the plurality of interrupt signal lines by use of the single signal line. The chip set 3 transmits the interrupt signals received from the EC 7 to the control unit 2.

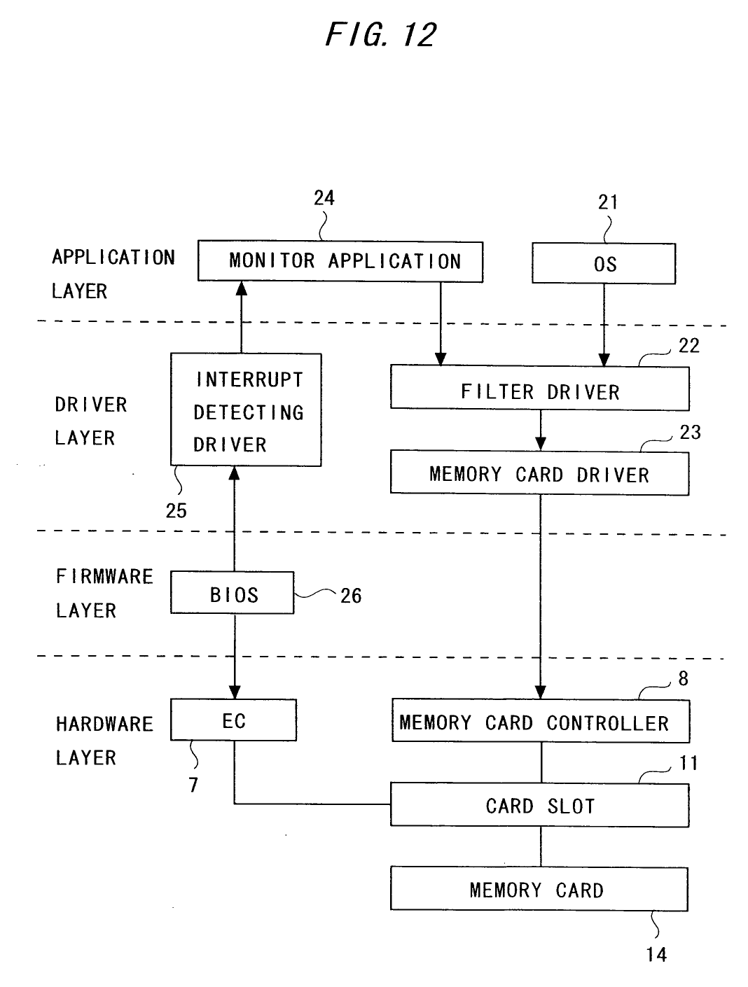

Next, an operation in a case where writing to the memory card 14 occurs will be explained. FIG. 12 is a conceptual diagram that explains an operation when making a write request and an operation when the interrupt occurs. When the writing to the memory card 14 occurs, the OS (Operating System) 21 sends a file write request to a memory card driver 23. Herein, a file is defined as an aggregation of data recorded in the recording unit 6 and stored in other storage devices. Further, the writing connotes transferring the data, copying the data and creating a new piece of data.

When the OS 21 sends the file write request to the memory card driver 23, for example, API (Application Program Interface) named “Write File” is used.

Further, the file write request is given via a filter driver 22 to the memory card driver 23 from the OS 21. Namely, when the OS 21 sends the file write request to the memory card driver 23, the OS 21 sends the file write request to the filter driver 22. Then, the filter driver 22 sends the file write request to the memory card driver 23.

The memory card driver 23 translates the file write request into a physical address of the memory card 14. Namely, the memory card driver 23, in the case of receiving the file write request, designates an address of a storage area of the write target memory card 14. Moreover, the memory card driver 23 may also translate the file write request into a logical address of the memory card 14. In this case, a controller within the memory card 14 translates the logical address into the physical address.

The memory card controller 8 receives the file write request via the memory card driver 23. To be specific, the memory card controller 8 receives the address designated by the memory card driver 23.

Then, the memory card controller 8 executes the writing to the memory card 14 inserted into the card slot 11.

Next, an operation when the interrupt occurs will be explained The control unit 2, when receiving the interrupt signal, starts up BIOS (Basic Input/Output System) 26. The BIOS 26 is stored (installed) in the ROM 4. The BIOS 26 after being started up accesses the EC 7. Then, the BIOS 26 analyzes an interrupt factor. Namely, the BIOS 26 judges whether the interrupt signal received by the control unit 2 is a card ejection interrupt signal or not.

If the interrupt signal received by the control unit 2 is the card ejection interrupt signal, the BIOS 26 sends an interrupt message to an interrupt detecting driver 25. In this case, the interrupt message is a message purporting that the interrupt occurs. The interrupt detecting driver 25 receiving the interrupt message sends the interrupt message to a monitor application 24. Then, the monitor application 24 receiving the interrupt message sends the interrupt message to the filter driver 22. The filter driver 22 receiving the interrupt message stops sending the write request to the memory card driver 23.

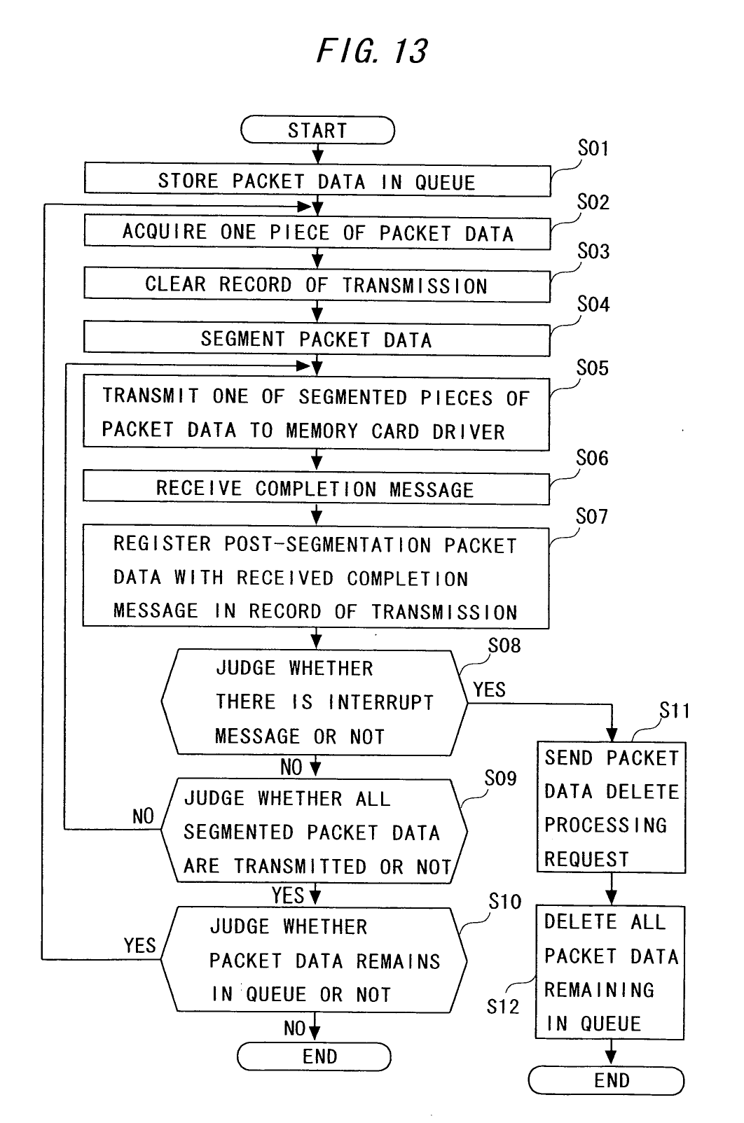

A detailed operation of the filter driver 22 will be described. FIG. 13 shows a flowchart of the operation when starting up the filter driver 22. The operation of the filter driver 22 is actualized in such a way that the filter driver 22 is loaded into the RAM 5 and the control unit 2 controls the execution thereof.

To start with, when the OS 21 makes the write request, the control unit 2 stores, in a queue, the write request target data as packet data (S01). The queue is a storage area, provided in the RAM 5, for storing the packet data. If there is a plurality of write request target files, it follows that there are plural pieces of packet data to be stored in the queue.

Next, the control unit 2 acquires one piece of packet data stored in the queue (S02). A scheme in this case is that none of the packet data acquired by the control unit 2 remains in the queue.

Then, the control unit 2 clears a record of transmission (S03). The record of transmission is a record showing completion of writing the write request target file. Further, the record of transmission is stored in the RAM 5. The record of transmission corresponds to a “write record” according to the present invention.

Next, the control unit 2 segments the packet data acquired from the queue (S04). For instance, the control unit 2 segments the packet data by the unit of 100 bytes, which is acquired from the queue. In this case, the segmented packet data is assigned a unique number. Further, the unit for the packet segmentation can be arbitrarily set.

Then, the control unit 2 transmits one of the segmented pieces of packet data (post-segmentation packet data) to the memory card driver 23 (S05).

Subsequently, the control unit 2 receives a completion message of the post-segmentation packet data transmitted to the memory card driver 23 (S06). The completion message is a message representing that the memory card controller 8 completes the writing to the memory card 14.

Then, the control unit 2 registers, in the record of transmission, information about the post-segmentation packet data of which the completion message has been received (S07). To be specific, the control unit 2 registers, in the record of transmission, the data number of the post-segmentation packet data of which the completion message has been received.

Next, the control unit 2 judges whether there is the interrupt message or not (S08). Namely, the control unit 2 judges whether or not the monitor application 24 sends the interrupt message to the filter driver 22.

If there is no interrupt message, the control unit 2 judges whether or not all the segmented packet data are transmitted to the memory card driver 23 (S09). If all the segmented packet data are transmitted to the memory card driver 23, the control unit 2 judges whether the packet data remains in the queue or not (S10). If the packet data remains in the queue, the control unit 2 returns to the process in S02. Whereas if the packet data does not remain in the queue, the control unit 2 finishes the operation of the filter driver 22.

Moreover, if there is the interrupt message (if judged to be affirmative in the process in S08), the control unit 2 sends to the memory card driver 23 a delete processing request of the packet data of which data number is registered in the record of transmission (S11). Then, the memory card driver 23 transmits the delete processing request to the memory card controller 8. The memory card controller 8 deletes the packet data with its writing completed out of the memory card 14 on the basis of the data number registered in the record of transmission.

Next, the control unit 2 deletes all the packet data remaining in the queue (S12). Further, the control unit 2 deletes all the segmented packet data. Thereafter, the control unit 2 finishes the operation of the filter driver 22.

Moreover, if all the segmented packet data are not transmitted to the memory card driver 23 (if judged to be negative in the process in S10), the control unit 2 returns to the process in S05. Then, the processes in S05 through S10 are repeatedly executed till all the segmented packet data are transmitted to the memory card driver 23.

In the present embodiment, the write request target data is segmented and thus written to the memory card 14. Then, each time the segmented data is written to the memory card 14, it is judged whether the memory card 14 is ejected or not. If the memory card 14 is ejected, none of the data is written to the memory card 14 from this onward.

If the writing of the data to the memory card 14 is completed before an elapse of ejection time, the write request target data is not destructed. The ejection time is a period of time expended till the memory card 14 is ejected from the card slot 11 since the memory card 14 has been intruded up to the innermost portion within the card slot 11.

In the present embodiment, the write request target data is segmented so that write time is shorter than the ejection time. The write time connotes a period of time elapsed till one of the segmented pieces of packet data is written to the memory card 14 since it has been judged whether the memory card 14 was ejected or not.

For instance, if the ejection time is on the order of 40 msec, the write request target data is segmented, thereby reducing the write time down to 3 micro sec. In this case, even if the operation of ejecting the memory card 14 is started simultaneously with the start of the writing, the writing of the data to the memory card 14 is to be completed before the elapse of the ejection time. The values given above are, however, exemplifications, and the ejection time and the write time are not limited to the values given above. The ejection time and the write time are, it is sufficient, obtained from actual measurement or simulation.

In the present embodiment, the write request target data is segmented and thus written to the memory card 14, thereby making it possible to prevent the data from being destructed due to the ejection of the memory card 14.

Moreover, in the present embodiment, when ejecting the memory card 14, in the segmented data, the data with its writing completed is deleted from the memory card 14. As a result, any part of the segmented data can not remain in the memory card 14.

<Computer Readable Recording Medium>

It is possible to record a program which causes a computer to implement any of the functions described above on a computer readable recording medium. By causing the computer to read in the program from the recording medium and execute it, the function thereof can be provided. The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM (Read Only Memory).

### <Others>

The disclosures of Japanese patent application No. JP2006-074590 filed on Mar. 17, 2006 including the specification, drawings and abstract are incorporated herein by reference.

What is claimed is:

1. An information processing device that writes data to an attachable/detachable recording medium, comprising:
data segmenting unit segmenting the data;
data writing unit writing the data segmented by said data segmenting unit to said recording medium; and
detecting unit detecting ejection of said attached recording medium,
wherein said data writing unit stops the writing when said detecting unit detects the ejection of said recording medium.

2. An information processing device according to claim 1, further comprising deleting unit deleting, when said detecting unit detects the ejection of said recording medium, the data written by said writing unit from said recording medium.

3. An information processing device according to claim 2, further comprising unit registering a write record of the data written to said recording medium by said data writing unit in the data segmented by said data segmenting unit,
wherein said deleting unit deletes, based on the write record, the data written by said writing unit from said recording medium.

4. A control method of an information processing device that writes data to an attachable/detachable recording medium, comprising:
a data segmenting step of segmenting the data;
a data writing step of writing the data segmented in said data segmenting step to said recording medium; and
a detecting step of detecting ejection of said attached recording medium,
wherein said data writing step includes stopping the writing when detecting the ejection of said recording medium in said detecting step.

5. A control method of an information processing device according to claim 4, further comprising a deleting step of deleting, when detecting the ejection of said recording medium in said detecting step, the data written in said writing step from said recording medium.

6. A control method of an information processing device according to claim 5, further comprising a registering step of registering a write record of the data written to said recording medium in said data writing step in the data segmented in said data segmenting step,
wherein said deleting step includes deleting, based on the write record, the data written in said writing step from said recording medium.

7. A computer readable storage medium storing a control program of an information processing device that writes data to an attachable/detachable recording medium, the control program causing the computer to execute the steps of:
a data segmenting step of segmenting the data;
a data writing step of writing the data segmented in said data segmenting step to said recording medium; and
a detecting step of detecting ejection of said attached recording medium,
wherein said data writing step includes stopping the writing when detecting the ejection of said recording medium in said detecting step.

8. A computer readable storage medium storing the control program according to claim 7, further comprising a deleting step of deleting, when detecting the ejection of said recording medium in said detecting step, the data written in said writing step from said recording medium.

9. A computer readable storage medium storing the control program according to claim 8, further comprising a registering step of registering a write record of the data written to said recording medium in said data writing step in the data segmented in said data segmenting step,
wherein said delete step includes deleting, based on the write record, the data written in said writing step from said recording medium.
